(19) United States
(12) Patent Application Publication
(10) Pub. No.: US 2009/0105933 A1
(43) Pub. Date: Apr. 23, 2009

(54) SYSTEM FOR PROVIDING VISUAL INFORMATION OF A REMOTE LOCATION TO A USER OF A VEHICLE

(75) Inventor: Paul Ernst Joachim Wlotzka, Nurtingen (DE)

Correspondence Address: THE ECLIPSE GROUP LLP, 10605 BALBOA BLVD., SUITE 300, GRANADA HILLS, CA, 91344, US

(73) Assignee: Harman Becker Automotive Systems GmbH, Karlsbad (DE)

(21) Appl. No.: 12/253,355

(22) Filed: Oct. 17, 2008

(30) Foreign Application Priority Data
Oct. 17, 2007 (EP) 07 020 296.5

(51) Int. Cl. G06F 19/00; G01C 21/26

(52) U.S. Cl. 701/117; 701/200

(57) ABSTRACT

In a system for providing visual information of a remote location to a user of a vehicle, one or more resources provide visual information of the remote location. Through an input unit, the user may select a remote location for which the visual information is to be requested and input a request for the visual information. A transmitting unit transmits the visual information from the resource to the user, and a display displays the requested visual information to the user. The system may also include a resource determining unit that determines the resource or the resources that are able to provide the requested visual information on the basis of positioning information of the remote location.

### RELATED APPLICATIONS

This application claims priority of European Patent Application Serial Number 07 020 296.5, filed on Oct. 17, 2007, titled METHOD AND SYSTEM FOR PROVIDING A VISUAL INFORMATION OF A REMOTE LOCATION TO A USER OF A VEHICLE, which application is incorporated in its entirety by reference in this application.

### BACKGROUND OF THE INVENTION

1. Field of the Invention

This invention relates to a system and method for providing visual information relating to a remote location to a user of a vehicle.

2. Related Art

Vehicle-based navigation systems are known that guide the driver of the vehicle from the present location to a predetermined destination. The navigation system may output driving indications either visually by indicating the driving direction on a display or orally by a voice output indicating the next driving maneuver. Separately, vehicles are often equipped with a wireless receiver such as a radio that provides the user access to broadcasted content relating to traffic and weather conditions. There is a need, however, for providing a system in which the user of the vehicle is presented with visual information of points or areas located remotely from the vehicle but along a driving route being contemplated by the user. Such visual information could be utilized, for example, to assist the user in determining the existence of undesirable traffic conditions (e.g., congestion, accident, construction, etc.) or weather conditions, points of interest at which the user may desire to visit or take a break from driving, verification or confirmation that a particular driving route suggested by the navigation system of the vehicle is up-to-date or is the most desirable route for the user, and the like. There is also a need for providing such a system that utilizes existing resources of visual information (e.g., sensors, cameras, or the like) located at various points along the route(s) being contemplated by the user. Existing resource may include, for example, cameras equipped in other vehicles, cameras provided with mobile communication devices, cameras provided with traffic monitoring equipment, and the like.

### SUMMARY

According to one implementation, a method for providing visual information of a remote location to a user of a vehicle is provided. The method may include the following steps. Position information of the remote location from which the visual information is to be provided to the user is determined. The position information is utilized to determine a resource that provides the visual information of the remote location. Then, the visual information is requested from the determined resource, and the visual information is transmitted from the determined resource to the user and displayed to the user.

According to another implementation, a system for providing visual information of a remote location to a user of a vehicle is provided. The system includes at least one resource providing visual information of the remote location, an input unit, a resource determining unit, a transmitting/receiving unit and a display. The input unit is configured for allowing the user to select the remote location for which the visual information is to be requested and to input a request for the visual information. The resource determining unit determines the resource or resources able to provide the requested visual information on the basis of positioning information of the remote location. The transmitting/receiving unit transmits the visual information from the resource to the user and the display displays the requested visual information to the user.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic view of an example of a system for providing visual information of a remote location to a user of a vehicle according to an implementation of the present invention.

FIG. 2a is an elevation view of an example of a navigation device according to an implementation of the invention.

FIG. 2b is another elevation view of the navigation device illustrated in FIG. 2a, where requested visual information of a remote location is displayed according to an implementation of the invention.

FIG. 3 is a schematic view of flow charts showing procedures performed in a resource, a server and a vehicle, according to an implementation of the present invention;

FIG. 4 is a schematic view of flow charts showing procedures performed in the resource, the server and the vehicle, according to another implementation of the present invention;

FIG. 5 is a schematic view of flow charts showing procedures performed in the resource, the server and the vehicle, according to yet another implementation of the present invention.

### DETAILED DESCRIPTION

In the following detailed description of the examples of various implementations, it will be understood that any direct connection or coupling between functional blocks, devices, components or other physical or functional units shown in the drawings or description in this application could also be implemented by an indirect connection or coupling. It will also be understood that the features of the various implementations described in this application may be combined with each other, unless specifically noted otherwise.

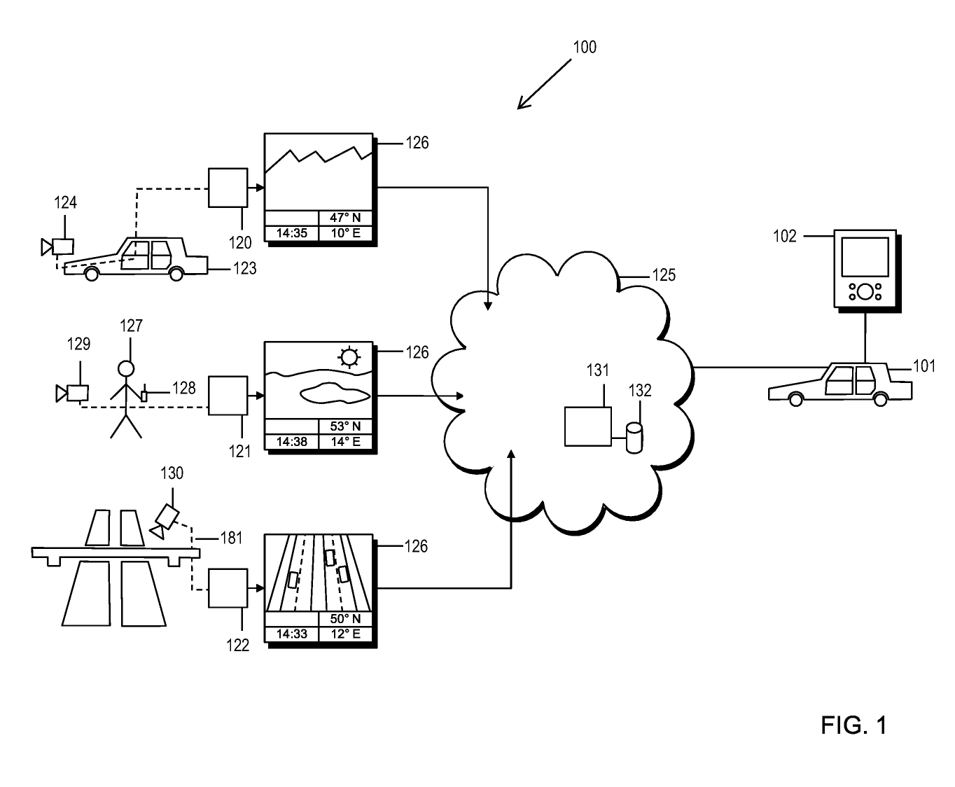

FIG. 1 is a schematic view of an example a system 100 for providing a visual information of a remote location to the user of a vehicle 101 according to one implementation. In this example, the user of the vehicle 101 is planning a trip with the help of a navigation device 102. After having input intermediate and final destinations into the navigation device 102, the navigation device 102 calculates a route to the desired destinations. In performing the calculation, the navigation device 102 may, for example, take into account information received via a traffic message channel (TMC) to assist the user in avoiding roads where congestions are present.

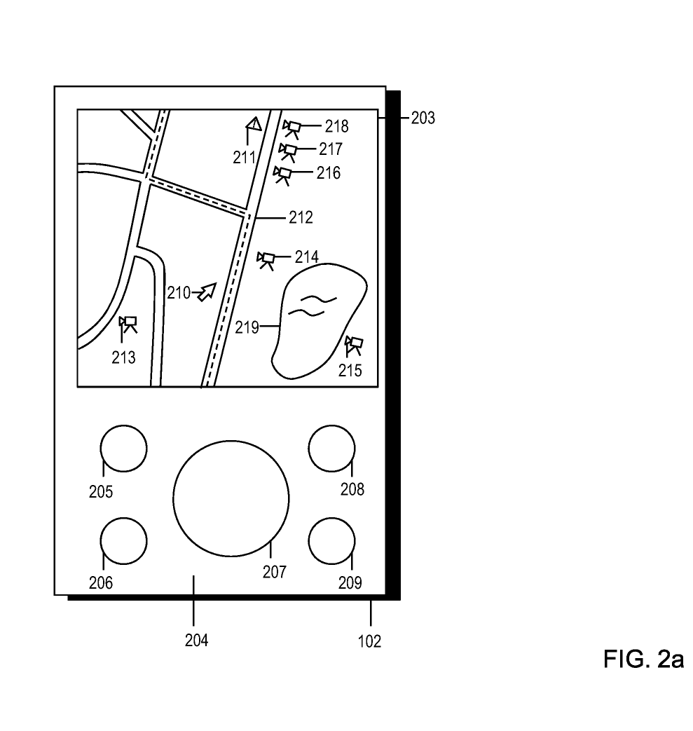

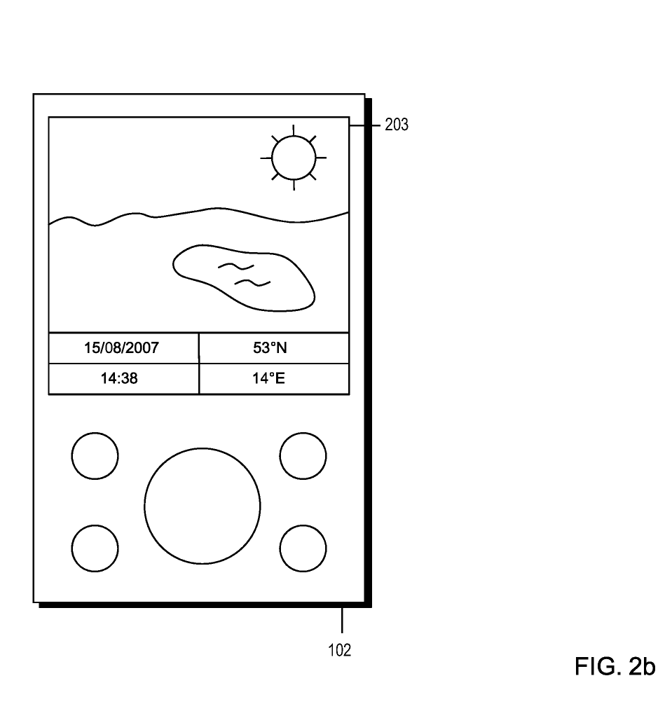

FIG. 2a is an enlarged elevation view of an example of the navigation device 102 illustrated in FIG. 1. The navigation device 102 may include a display 203 and an input unit 204. The input unit 204 may include several control keys 205-209 for moving a pointer 210 displayed on the display 203 and for controlling and operating functions of the navigation device 102. Although not shown, the input unit 204 may comprise any other haptic or optical input means, e.g., a touch screen integrated in display 203, a touch pad, a camera recognizing gestures of a user utilizing the navigation device 102, or an eye tracking system recognizing the movements of the eyes of the user utilizing the navigation system 102. As also shown in FIG. 2a, a map is displayed on the display 203 of the navigation device 102. The map shows a part of the route proposed by the navigation device 102. In this example, the navigation device 102 has determined the existence of traffic congestion on the shortest path to the destination, and the navigation device 102 has calculated a route circumnavigating the congestion. The congestion is displayed by a warning sign 211 in FIG. 2a. The calculated route circumnavigating the congestion is shown by the dashed line in FIG. 2a. As can be seen, the navigation device 102 has calculated a route which turns to the left at a point 212 to assist the user in avoiding running into the congestion indicated by the warning sign 211. The planned traveling direction in this example is assumed to be from the bottom to the top in FIG. 2a.

Additionally, camera symbols 213-218 are displayed on the display 203 of the navigation device 102. These camera symbols 213-218 indicate locations at which a visual information is available. These locations will be referred to as remote locations in the present description, as they are remote locations in view of the current position of the user of the vehicle 101. The user of the vehicle 101 may now select, with the help of the input unit 204 and the pointer 210, the camera symbol 214 and receive in response to this selection an image of a road section in front of the point 212. With this information, the user of the vehicle 101 is able to check if the congestion indicated by the warning sign 211 is currently really on the road section behind point 212 only, or if the congestion is already longer than predicted by the TMC and interferes with the traffic on the road section before point 212. Then the user of the vehicle 101 can additionally request visual information of the remote locations indicated by camera signs 216-218. With the help of this visual information the user can determine if the congestion notified by the TMC is really still existing, or if the traffic is already starting to flow, or determine the reason for the congestion, for example whether there was an accident and whether still one or more lanes are blocked due to this accident. With the help of the visual information of the remote locations, the user of the vehicle 101 is now able to decide whether the user should follow the circumnavigation or drive straight ahead at point 212 assuming that the congestion does not exist any more when reaching this section of the road.

Furthermore, the user of vehicle 101 may decide to take a break at a lake 219 shown on the display 203, hoping that the congestion will not exist any more after the break. Therefore, the user may select the camera symbol 215 to receive a visual information of the remote location near the lake 219 to check if the weather and the area near the lake 219 is convenient for a break. FIG. 2b is another illustration of the navigation device 102, where an image of the remote location near the lake 219 is displayed after having selected the camera symbol 215 shown in FIG. 2a. In addition to the visual information of the lake 219 displayed on the display 203 of the navigation device 102, a position information showing the longitude and latitude of the position from which the visual information was captured and a time and date information, indicating the time and date when the visual information was captured, may be provided. Alternatively, the visual information may be displayed with the position information only, with the time and date information only, or without any further information.

Referring again to FIG. 1, the system 100 for providing a visual information of a remote location will be described in more detail. The system 100 may include several resources 120-122 providing visual information 126 of remote locations. Such a resource may for example be included in a vehicle 123, a mobile navigation device or mobile phone 128, or a traffic monitoring equipment 181.

As shown in FIG. 1, a resource 120 may be included in a vehicle 123 that may include a camera 124. The camera 124 may, for example, be part of a driver assistance system of the vehicle 123 or may be exclusively designated for use with the resource 120. The resource 120 is adapted to receive visual information 126 captured by the camera 124 and may be configured to transmit the visual information 126 to a data transmission network 125 via a transmitting/receiving unit of the resource 120. Additionally, the resource 120 may be adapted to store the visual information 126 received from the camera 124 inside the resource 120 in a memory unit of the resource 120 and transmit the visual information 126 on a request received by the transmitting/receiving unit of the resource 120 to the data transmission network 125. The resource 120 may store the received visual information 126 continuously, in predetermined intervals, or on request. The period length of the predetermined intervals may be configurable by a user of the vehicle 123. The visual information 126 may be stored in a memory unit, in which case old visual information may be automatically removed from the memory. The visual information 126 captured by the camera 124 may comprise still images or a video stream. The resource 120 may additionally be adapted to determine a position information of the resource 120 with a position determining unit of the resource 120, for example using a global positioning system (GPS), and to determine the current date and time and to store and transmit this position and time and date information together with the visual information 126.

A resource 121 may also be included with or incorporated into a mobile device 128, for example a mobile phone or a mobile navigation device. As shown in FIG. 1, a user 127 carrying the mobile device 128, which may include the resource 121, may take a picture or record a video stream at a certain location with the mobile device 128, which may include a camera 129. The user 127 may then decide to publish the captured visual information 126 by activating a publishing function of the mobile device 128, and in response to this, the resource 121 may store the visual information 126 together with a position information and a time and date information in a memory unit of the resource 121 such that the visual information 126 is subsequently available in response to a request for the visual information 126. As an alternative or in addition to storing the captured visual information 126, the resource 121 may directly transmit the visual information 126 together with the position information and the time and date information to the data transmission network 125.

Additionally or as an alternative, the position information may be added to the visual information 126 by a base station of the data transmission network 125 receiving the visual information from the resource 120 and/or 121.

As shown in FIG. 1, the visual information 126 may be provided by a traffic monitoring device or equipment 181 that may include a camera 130 and a resource 122. The traffic monitoring equipment 181 may be provided, for example, on a bridge monitoring the traffic on a section of a road running underneath the bridge. The resource 122 may provide, either continuously or on request, visual information 126 together with a position information and a time and date information to the data transmission network 125.

The data transmission network 125 may include any kind of wireless and wire-based data transmission means and corresponding routers and hubs to provide the data communication between the resources 120-122 and the navigation device 102 of the user of vehicle 101. The data transmission network 125 may additionally include a server 131 that includes a database 132. The server 131 may be adapted to store visual information 126 received from the resources 120-122 and to transmit the visual information 126 to the navigation device 102. Furthermore, the server 131 may be adapted to keep track of the position of the resources 120-122, for example by analyzing the visual information 126 containing position information of the resource 120-122, by determining the position information of a base station providing contact to the resource 120-122, or by receiving a position information of the resource 120-122 sent by the resource 120-122 to the server 131. Finally, the server 131 may be adapted to transmit the visual information 126 received from the resources 120-122 to the navigation device 102 in response to a request from the navigation device 102, and to provide the position information of the resources 120-122 to the navigation device 102, for displaying the location of the resource 120-122 on the navigation device 102.

The server 131 may be adapted to store the visual information 126 received from the resources 120-122 in a data base 132 of the server 131, where old visual information may be automatically removed from the data base 132.

According to an implementation, a system for providing visual information of a remote location to a user of a vehicle is provided. An example of such a system 100 is illustrated in FIGS. 1-2b. The system 100 includes at least one resource 120, 121 or 122 providing visual information 126 of the remote location, an input unit 204, a resource determining unit, a transmitting/receiving unit and a display 203. Using the input unit 204, the user may select a remote location for which the visual information 126 is to be requested and inputs a request for the visual information 126. The resource determining unit and the transmitting/receiving unit may be embodied, for example, in the navigation device 102, in whole or in part, or otherwise be in communication with the navigation device 102 or other device of the vehicle 101. The resource determining unit determines the resource or resources 120, 121 and/or 122 being able to provide the requested visual information 126 on the basis of a positioning information of the remote location. The transmitting/receiving unit transmits the visual information 126 from the resource 120, 121 and/or 122 to the user and the display 203 displays the requested visual information 126 to the user.

The resource 120, 121 and/or 122 may comprise a sensor generating video data of the remote location. The video data may comprise still images or a video stream. The resource 120, 121 and/or 122 may be located on a vehicle 123, a traffic monitoring device 181, a mobile phone 128, a mobile navigation device 128, or may be carried around by a person as an individual mobile device 128. Therefore, a number of different types of resources 120, 121 and 122 may be provided near the remote location of which the visual information 126 is to be provided to the user, and therefore the user is able to select from a variety of resources 120, 121 and 122 to get the information the user is interested in.

The input unit 204 may be part of a navigation device 102 of the vehicle 101. Furthermore, the display 203 may be configured to show the resources 120, 121 and 122 that are available for selection by the user. The display 203 may also be part of the navigation device 102 of the vehicle 101. By integrating the input unit 204 and the display 203 into the navigation device 102, the cost for the system 101 may be reduced by sharing the input unit 204 and the display 203 with the navigation device 102, and selection of a remote location by the user is simplified by selecting the desired remote locations on the display 203 displaying the route determined by the navigation device 102.

As already stated above, the resource 120, 121 or 122 may be adapted to determine time information and to transmit the visual information 126 together with the time information to the user. Furthermore, the resource 120, 121 or 122 may comprise a position determining unit and may be adapted to transmit the visual information 126 together with a position information determined by the position determining unit.

In some implementations, the system 100 includes a server 131 in a data transmission network 125. The network 125 enables a communication between the resource 120, 121 or 122 and the server 131, between the resource 120, 121 or 122 and the user, and/or between the user and the server 131. The resource 120, 121 or 122 may include a position determining unit and transmit the position information of the position determining unit to the server 131. With the help of the position information received from the resource 120, 121 and/or 122, the server 131 may determine, on the basis of a position information of the remote location, the resource 120, 121 and/or 122 that is able to provide the requested visual information 126 of a remote location. Additionally or alternatively, the resource 120, 121 or 122 may be coupled to the data transmission network 125 via a base station connected to the data transmission network 125. When the resource 120 or 121 is included in a mobile phone 128 or included in a navigation device connectable to a cellular communication system, the base station may be a base station of the wireless cellular communication network. In this case the server 131 may determine the position information of the resource 120 or 121 via the predetermined position information of the base station. Although in this case the position information may not provide an accuracy as high as a position information provided by a global positioning system, for example a GPS system, this position information is available at very low cost, especially if the resource 121 is included in a mobile phone 128.

In some implementations, the resource 120 or 121 includes an input unit allowing one to request a provision of the visual information 126 of the surrounding of the resource 120 or 121, i.e., of the remote location. Upon a request triggered by the input unit of the resource 120 or 121, the visual information 126 may be stored in a server 131 of the data transmission network 125. Alternatively or additionally, the visual information 126 provided upon request may be stored in a memory unit of the resource 120 or 121. Furthermore, the resource 120 or 121 may additionally provide and store the visual information 126 continuously in the server 131 and/or the memory unit for a predetermined amount of time. By providing the visual information 126 by the resource 120 or 121 upon actuation of the input unit of the resource 120 or 121, a person using the resource 120 or 121, which may be part of a mobile phone 128 or a mobile navigation device 123, may on his own initiative provide visual information 126 that may be of interest to other persons. For example, a person using the resource 120 or 121, driving in a car and recognizing the beginning of a new congestion or the development of bad weather, may therefore provide traffic- or weather-related information to other road users much in advance to a usual traffic message channel by simply pressing a corresponding button on the input unit.

It will be understood that the features of the various exemplary implementations described above may be combined with each other, unless specifically noted otherwise.

According to another implementation, a method for providing a visual information 126 of a remote location to a user of a vehicle 101 is provided. The method may include the following steps. A position information of the remote location from which the visual information 126 is to be provided to the user is determined. The position information may be utilized to determine a resource 120, 121 and/or 122 that provides the visual information 126 of the remote location. Then, the visual information 126 is requested from the determined resource 120, 121 and/or 122, and the visual information 126 is transmitted from the determined resource 120, 121 and/or 122 to the user and displayed to the user.

This method allows the user of the vehicle 101 to get reliable information of the remote location the user wants to travel along and therefore provides a reliable basis for planning a route or a trip with the vehicle 101.

The resource 120, 121 and/or 122 may provide the visual information 126 together with a position information of the visual information 126, for example in the form of geographical data indicating longitude information and latitude information, for example as a text displayed in the visual information 126 in the form of digital data provided with the digital data of a picture (see, for example, FIG. 2b). Furthermore, the resource 120, 121 and/or 122 may provide the visual information 126 together with a time information indicating the time and date of a detection of the visual information 126 (FIG. 2b). Providing the position information and the time information together with the visual information 126 helps to increase the confidence of the user in the visual information 126 displayed to be detected at the desired location and to be up-to-date. Furthermore, the visual information 126 may be archived together with the position information and the time information and be requested later on by a user who is mainly not interested in an up-to-date information but in a visual information 126 about the remote location in general, for example when the user is planning a sightseeing trip to the location.

In some implementations, the visual information 126 may be detected by the resource 120, 121 and/or 122 in response to a request of the visual information 126, or the visual information 126 may be detected by the resource 120, 121 and/or 122 continuously and the detected visual information 126 may then be stored in the resource 120, 121 and/or 122. Detecting the visual information 126 in response to a request guarantees an up-to-date information presented in the visual information 126. Detecting the visual information 126 continuously and storing the visual information 126 may be utilized advantageously in, for example, the followings ways: first, in case currently no resource 120, 121 and/or 122 is able to detect an up-to-date information, a former visual information of the remote location may be provided being as up-to-date as possible, and, second, historical information may be provided and may be utilized for analyzing traffic information, analyzing an accident or providing sightseeing information of the remote location.

In various implementations, the resource 120, 121 or 122 may be included in another vehicle 123, a mobile navigation device 128, a mobile phone 128, and/or traffic monitoring equipment 181. When provided in another vehicle 123, the resource 120 may be utilized in combination with a camera 124 of a driver assistance system of the vehicle 123 and therefore such a configuration does not require additional effort and costs. When the resource 121 is included in a mobile navigation device 128, the above-described position information provided together with the visual information 126 can be easily determined by the mobile navigation device 128. Furthermore, if the resource 121 is included in a mobile navigation device 128 having a camera 129, the mobile navigation device 128 may be utilized for taking pictures, which may be archived in the resource 121 together with the position information and therefore the pictures can be easily associated with a remote location. When the resource 121 is included in a mobile phone 128 having a camera 129, the resource 121 may detect the visual information 126 of the remote location with the camera 129 of the mobile phone 128 and transmit the visual information 126 in response to a request received via the radio transmission capabilities of the mobile phone 128 to the requesting user. Therefore, when integrated in a mobile phone 128, providing a visual information 126 of a remote location to a user of a vehicle 101 may be implemented with very low additional costs in a mobile phone 128. When included in a traffic monitoring equipment 181 that may be located for example on a bridge over a road or at a crossing, the resource 122 may utilize the camera 130 of the traffic monitoring equipment 181 for detecting the visual information 126 of the remote location and may utilize the data communication infrastructure 125 of the traffic monitoring equipment 181 for receiving requests for visual information 126 and for transmitting the visual information 126 to a requester. Additionally, the resource may utilize a camera of a helicopter of the police or an automobile club, or may utilize a camera of a toll collect system installed near a road. Therefore, the method for providing the visual information 126 of a remote location may be easily integrated into a traffic monitoring equipment 181 with low additional costs.

The remote location may be located on a user's route to a predetermined destination. When the user has planned a route to a predetermined destination, for example with the help of a mobile navigation device 102, there may be one or more remote locations of which the user is interested in visual information 126, for example due to traffic information heard in the radio or due to weather information read in a newspaper or heard in the radio. To get an idea of whether it would be advantageous for the user to circumnavigate this remote location, it is advantageous for the user to retrieve a visual information 126 of the remote location located on or nearby the user's route.

In some implementations, the step of requesting the visual information 126 includes the step of transmitting the request to a server 131 of a data transmission network 125. The server 131 determines a resource 120, 121 and/or 122 that is located within a predetermined distance to the remote location from which the visual information 126 is requested. Such an implementation simplifies the determination of a resource 120, 121 and/or 122 providing the visual information 126 of the remote location. The server 131 of the data transmission network 125 keeps track of the resources 120, 121 and/or 122 providing the visual information 126 of the remote locations. A user requesting a visual information 126 of a remote location may put this request to the server 131 only and the server 131 then forwards the request to the resource 120, 121 and/or 122 nearest to the requested remote location. The requested visual information 126 may then either be transmitted from the determined resources 120, 121 and/or 122 to the server 131 and then transmitted from the server 131 to the user, or be directly transmitted from the determined resources 120, 121 and/or 122 to the user. However, the resource 120, 121 and/or 122 may be directly determined without the use of a server 131 and the request may also be directly transmitted to the resource 120, 121 and/or 122 without the use of a server 131.

In some implementations, the resources 120, 121 and/or 122 able to provide the visual information 126 for a predetermined remote location are displayed for example on a map of a navigation device 102 to the user. Then the user can select at least one of the resources 120, 121 and/or 122 from which the visual information 126 is to be provided, and then the visual information 126 of the at least one selected resource 120, 121 and/or 122 is displayed to the user. This implementation is very easy to use, especially if the display 203 of a navigation device 102 of the vehicle 101 is utilized. When the user of the vehicle 101 plans a trip or route with the help of the navigation device 102, the navigation device 102 immediately shows all the locations where resources 120, 121 and 122 are available that are able to provide the visual information 126 of the remote locations. Additionally, the navigation device 102 may display congestions on the route based on the information received via a traffic message channel (TMC). The user then simply selects one of the displayed resources 120, 121 and 122 located near the congestion and decides based on the visual information 126 of the remote location received from the resource 120, 121 and 122 whether it is necessary to circumnavigate the congestion or not. In the same way the user of the vehicle 101 may check for weather conditions of parts of the route planned on the navigation device 102.

The visual information 126 may include a still image or a video stream. Still images, especially if they are compressed, can be easily and quickly transmitted via a wireless transmission network 125, as only small data volumes need to be transmitted. If data communication channels having a large bandwidth are available, the visual information 126 may include video streams that provide the user of the vehicle 101 with a more accurate information about the remote location, for example about the current traffic flow in a congestion.

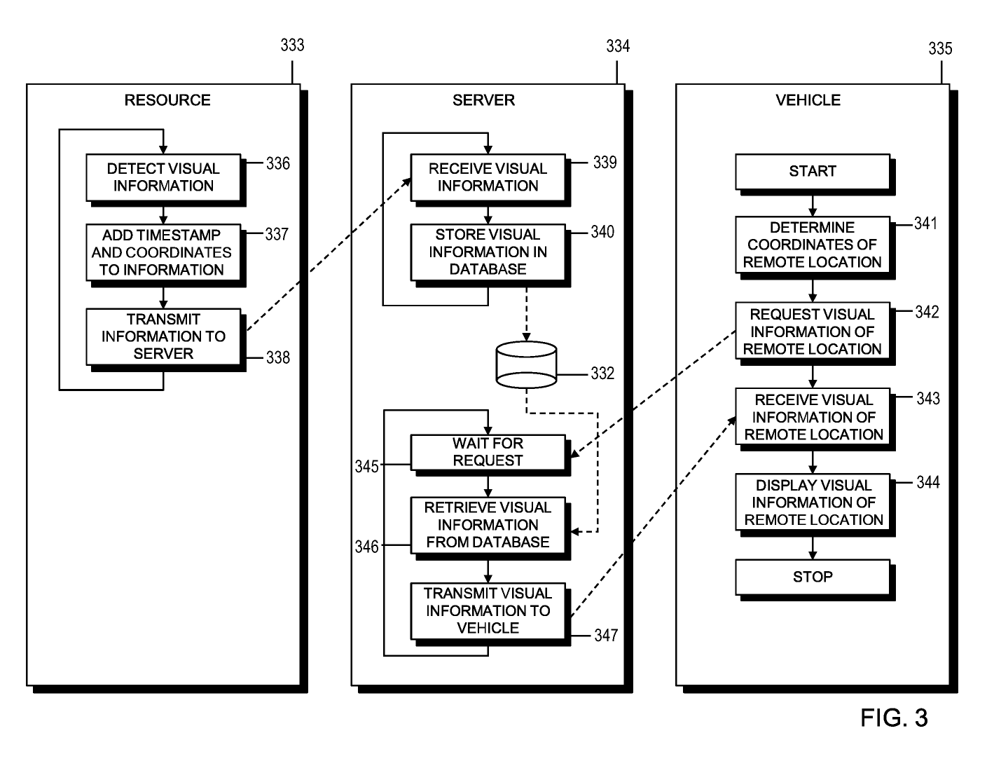

FIG. 3 is a schematic view of an example of an implementation in the form of flowcharts describing the actions to be performed on the resource 120-122, the server 131 and the vehicle 101 and the interaction between the resource 120-122, the server 131 and the vehicle 101.

The actions performed in the resource 120-122 are depicted in the resource block 333, the actions performed in the server 131 are depicted in the server block 334, and the actions performed in the vehicle 101 or in the navigation device 102 of the vehicle 101 are depicted in the vehicle block 335. Data flows between the blocks are indicated by arrows having dashed lines.

According to this implementation, the resource is continuously detecting visual information (block 336), adding time stamp and position information to the visual information (block 337), and transmitting the combined information to the server (block 338) of the data transmission network 125. The resource continuously detecting and providing visual information is, for example, a resource 120 included in a vehicle 123 or a resource 122 of a traffic monitoring equipment 181 as shown in FIG. 1. As shown in the server block 334 of FIG. 3, the server 131 of the data transmission network 125 receives the visual information (block 339) continuously and stores the received visual information (block 340) in a database 332. As shown in the vehicle block 335 in FIG. 3, the user of vehicle 101, after having planned a trip with the help of the navigation device 102, determines coordinates of remote locations (block 341) with the help of the navigation device 102, for example as already explained in conjunction with FIG. 2a. Then the navigation device 102 sends a request for visual information of the remote location (block 342) via the data transmission network 125 to the server 131. The server 131, waiting for a request from the vehicle 101, receives the request (block 345) and retrieves the requested visual information from the database 332 (block 346) using the coordinates of the remote location that has been sent together with the request for visual information from the vehicle 101. Then the server 131 transmits the visual information retrieved from the database 332 to the navigation device 102 of the vehicle 101 (block 347) and is then ready to receive the next request. In the vehicle 101, the navigation device 102 receives the visual information of the remote location (block 343) from the server 131 and displays the visual information of the remote location (block 344) to the user of the vehicle 101. As described above, the user may then decide with the help of the visual information to change the route accordingly.

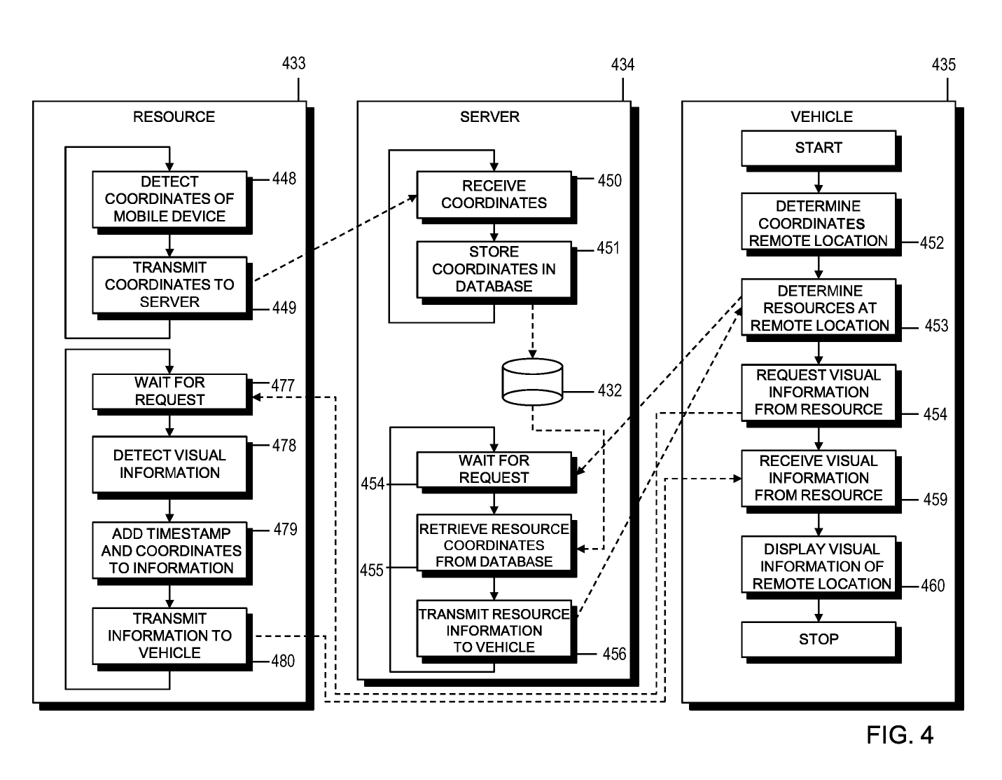

FIG. 4 is a schematic view in the form of a flowchart illustrating the actions performed in the resource 120-122, the server 131 and the vehicle 101 according to another implementation of the present invention.

According to this implementation, the resource 120-122 continuously detects the position information (coordinates) of the resource (block 448) and continuously transmits the coordinates to the server (block 449). The resource may be included in a driving assistance system in a vehicle or in a mobile device, such as a mobile phone or a mobile navigation device. As shown in the server block 434, the server 131 continuously receives the coordinates from the resource (block 450) and stores the received coordinates in a database 432 (block 451).

As shown in the vehicle block 435, coordinates of a remote location are determined (block 452). This may be accomplished for example by a user of a vehicle as described in conjunction with FIG. 2a. First, the user plans a trip with the help of the navigation device 102. Then, after the trip has been calculated by the navigation device 102, the navigation device 102 requests the coordinates of resources located near or within a certain range to the calculated route for the trip from the server. The locations of the available resources are then displayed on a display of the navigation device 102 in combination with the map information as shown in FIG. 2a. Then the user selects one of the resources with the help of a pointing device 210 and an input unit 204 of the navigation device 102 and thus the coordinates of the remote location are determined. As an alternative, the user of the vehicle 101 may select any point in the map displayed on the navigation device 102 to request a visual information of that selected remote location. In either case, the navigation device 102 determines the resource at the desired remote location by sending a request containing the coordinates of the desired remote location to a server (block 453). In return, the server that was waiting for the request (block 454) retrieves a resource matching the coordinates of the desired remote location from the database 432 (block 455). In a case when no exact match of the coordinates can be found, a resource within a certain predetermined range is selected as the resource matching best to the desired coordinates. Then the server transmits the resource access information, for example an IP address or a telephone number adapted to get into contact with the resource, to the vehicle (block 456). The navigation device 102 of the vehicle 101 then utilizes the resource access information received from the server to request a visual information from this resource (block 454). Upon receiving the request from the navigation device 102, the resource, which was waiting for the request (block 477), detects the visual information of the surrounding of the resource (block 478) and adds a time stamp and position information to the visual information (block 479). Finally, the resource transmits the visual information together with the time stamp and position information to the vehicle (block 480). The navigation device 102 of the vehicle 101 receives the visual information from the selected resource (block 459) and displays the visual information of the remote location to the user (block 460).

When requesting a visual information of a remote location, the request may additionally include information specifying a kind of desired visual information, e.g., visual information including road views only, or visual information including service areas only, or visual information including certain points of interest only. By restricting the kind of desired visual information, e.g., a user who is interested in the current state of a congestion can restrict the kind of visual information to road views and gets in return visual information including road views only instead of visual information including non-road views, like e.g., a view of a lake or another point of interest near the requested remote location.

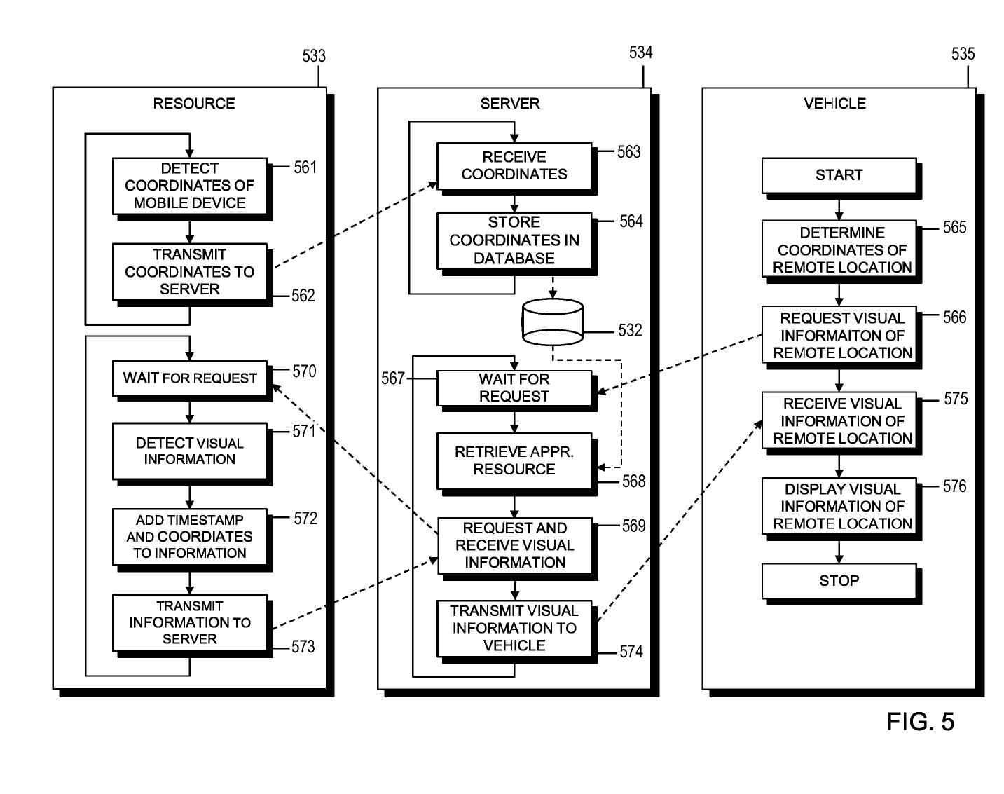

FIG. 5 is a schematic view of flowcharts of yet another example of an implementation. As shown in the resource block 533, the resource continuously detects the coordinates of the resource (block 561), which may be included in a mobile device 128 or a vehicle 123. The current coordinates or position information are transmitted to a server of the data transmission network (block 562). The server receives the coordinates (block 563) and stores the coordinates in a database 532 (block 564). In the vehicle, as shown in the vehicle block 535, after coordinates of a desired remote location have been determined (block 565) as described above, a request for visual information of a remote location are sent from the navigation device 102 of the vehicle 101 to the server (block 566). The server, which was waiting for the request from the navigation device (block 567), retrieves, in response to the request and utilizing the coordinates of the remote location, an appropriate resource for providing the requested visual information of the remote location from the database 532 (block 568). Then the server requests a visual information from the selected resource (block 569). In return to this request, the resource detects the visual information (block 571), adds a time stamp and position information to the visual information (block 572), and transmits the requested visual information to the server (block 573). After having received the visual information from the resource (block 569), the server transmits the visual information to the vehicle (block 574). Finally, in the vehicle the navigation device 102 receives the visual information of the remote location from the server (block 575) and displays the visual information to the user (block 576).

While exemplary implementations have been described above, various modifications may be implemented in other implementations. For example, the visual information (e.g., visual information 126 shown in FIG. 1) may include not only still image information, but also video streams of the surrounding at the remote location. Furthermore, a user who is utilizing a mobile device outside a vehicle, for example a mobile navigation device or a mobile phone, can request in the same way visual information of a remote location.

The resource 120 or 121, which may be provided in a mobile device 128, such as a mobile navigation device, or a mobile phone, or in a vehicle 123, may provide a special function activated for example via a certain key or a soft key for generating a visual information and transmitting this visual information to a predetermined destination. This may for example be utilized in the event of an accident, where a person near the accident takes one or more pictures of the accident and transmits these pictures with the help of this special function directly to the police or a rescue center to provide detailed information about the situation at the scene of the accident and additionally the exact position information of the accident.

When the resource 120 is part of a vehicle 123, for example part of a driving assistance system, pictures can be recorded continuously together with the time and position information to be utilized in the event of an accident of the vehicle 123 to reconstruct and analyze the accident.

Furthermore, the navigation device 102 of the vehicle 101 may be removable from the vehicle 101 and usable outside the vehicle 101. The navigation device 102 may additionally include a camera and may therefore be utilized during holidays or a journey for taking pictures or video streams of places of interest, which may then be sent together with the position information to a server 131 in the data transmission network 125 where this visual information is stored. This visual information may be requested by other persons who are interested in traveling to this location such that a tourist guide book is set up by this in the server 131 of the data transmission network 125.

The visual information may additionally be provided with some lines of text describing the content or some more details about the location or place depicted in the visual information. As an example, this visual information may comprise a photo of a restaurant and additionally some information about the meals the person taking the picture recommends. As the visual information is stored in the server 131 together with the position information, a time and date information and possibly such a recommendation, another person retrieving this information from the server 131 can easily program a navigation device 102 to navigate to this location and gets an impression of the site and the restaurant in advance.

As the navigation device 102 described above, which may be removable from the vehicle 101, is charged by the vehicle 101 when attached to the vehicle 101, the navigation device 102, which may also be utilized as a digital camera as described above, can be easily charged during a journey without providing a separate charger and without searching for a matching power supply line.

Finally, instead of communicating via a data communication network 125, the navigation device 102 and the resource 120-122 may communicate directly. The navigation device 102 may e.g., broadcast a request for visual information via e.g., a predetermined frequency or channel to all resources 120-122 within the reach of the transmitter of the navigation device 102. A resource 120-122 receiving this request may evaluate this request and, in case the resource 120-122 can provide the requested visual information, may respond to this request by sending the requested visual information directly to the navigation system 102. To avoid collisions when transmitting and responding to the request, any known collision detection protocol for wireless communication may be utilized.

It will be understood, and is appreciated by persons skilled in the art, that one or more processes, sub-processes, or process steps described in connection with FIGS. 1-5 may be performed by hardware and/or software. If the process is performed by software, the software may reside in software memory (not shown) in a suitable electronic processing component or system such as, one or more of the functional components or modules schematically depicted in FIGS. 1-5. The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any means that may contain, store, communicate, propagate, or transport the program for use by or in connection with the instruction execution system, apparatus, or device. The computer readable medium may selectively be, for example, but is not limited to, an electronic, magnetic, optical, electromagnetic, infrared, or semiconductor system, apparatus, device, or propagation medium. More specific examples, but nonetheless a non-exhaustive list, of computer-readable media would include the following: an electrical connection (electronic) having one or more wires, a portable computer diskette (magnetic), a RAM (electronic), a read-only memory “ROM” (electronic), an erasable programmable read-only memory (EPROM or Flash memory) (electronic), an optical fiber (optical), and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A method for providing a visual information of a remote location to a user of a vehicle, the method comprising:
determining a position information of the remote location from which the visual information is to be provided to the user;
determining a resource by utilizing the position information, said resource providing said visual information of said remote location;
requesting said visual information from the determined resource; and
transmitting said visual information from the determined resource to the user and displaying said visual information to the user.

2. The method of claim 1, where the resource provides the visual information together with a position information of the visual information.

3. The method of claim 1, where the resource provides the visual information together with a time information indicating the time and date of detection of the visual information.

4. The method of claim 1, where the visual information is detected by the resource in response to the requesting said visual information.

5. The method of claim 1, where said visual information is detected by the resource continuously and the detected visual information is stored in the resource.

6. The method of claim 1, where the resource is located in another vehicle, a mobile navigation device, a mobile phone, or a traffic monitoring device.

7. The method of claim 1, where the remote location is located on a user's route to a predetermined destination.

8. The method of claim 1, where requesting said visual information includes transmitting the request to a server of a data transmission network, and further including the server determining one or more resources located within a predetermined distance to the remote location from which the visual information is requested.

9. The method of claim 8, further including the one or more determined resources transmitting the requested visual information to the server, and the server transmitting the visual information to the user.

10. The method of claim 1, where the determined resources transmit the requested visual information directly to the user.

11. The method of claim 1, where the visual information allows to determine traffic situation at the remote location.

12. The method of claim 1, where the visual information allows to determine weather condition at the remote location.

13. The method of claim 1, further including displaying the resources able to provide the visual information for a predetermined remote location to the user, the user being able to select at least one of the resources for which the visual information is to be provided, the visual information of the selected at least one resource being displayed to the user.

14. The method of claim 1, where the visual information includes a still image or a video stream.

15. The method of claim 1, where the visual information is provided by a camera installed in another vehicle, by a camera installed in a traffic monitoring equipment, and/or a camera carried by another person.

16. A system for providing a visual information of a remote location to a user of a vehicle, the system comprising:
at least one resource providing visual information of the remote location;
an input unit allowing the selection of the remote location by the user and an input of a request for the visual information;
a resource determining unit determining the resource being able to provide the requested visual information on the basis of a position information of the remote location;
a transmitting/receiving unit transmitting the visual information from the resource to the user; and
a display displaying the requested visual information to the user.

17. The system of claim 16, where the resource includes a sensor generating video data of the remote location.

18. The system of claim 16, where the resource is located on a vehicle, a person, or a traffic monitoring equipment.

19. The system of claim 16, where the input unit is part of a navigation device of the vehicle.

20. The system of claim 16, where the display is configured to show resources for selection by the user.

21. The system of claim 16, where the resource determines time information and transmits the visual information together with the time information to user.

22. The system of claim 16, where the resource includes a position determining unit and transmits the visual information together with a position information.

23. The system of claim 17, where the sensor generates a video stream or a still image.

24. The system of claim 16, further including a server in a data transmission network, the network allowing communication between the resource and the server, between the resource and the user, or between the user and the resource.

25. The system of claim 24, where the resource includes a position determining unit and transmits the position information to the server.

26. The system of claim 24, where the resource is coupled to the data transmission network via a base station connected to the data transmission network, the server determining the position information of the resource via a predetermined position information of the base station.

27. The system of claim 24, where the resource includes an input unit allowing to request a provision of the visual information of the remote location, the visual information being stored in the server in the data transmission network.

28. The system according to claim 16, where the resource includes an input unit allowing to request a provision of the visual information of the remote location and a memory unit, the visual information being stored in the memory unit.

29. The system according to claim 16, where the resource continuously provides visual information of the remote location and the resource includes a memory unit storing the continuously provided visual information for a predetermined amount of time.
